(19) United States
(12) Patent Application Publication
(10) Pub. No.: US 2015/0253023 A1
(43) Pub. Date: Sep. 10, 2015

(54) METHOD AND APPARATUS IN A PNEUMATIC PIPE CONVEYING SYSTEM FOR MATERIAL

(71) Applicant: MARICAP OY, Vantaa (FI)

(72) Inventor: Göran Sundholm, Tuusula (FI)

(73) Assignee: MARICAP OY, Vantaa (FI)

(21) Appl. No.: 14/425,673

(22) PCT Filed: Sep. 2, 2013
(86) PCT No.: PCT/FI2013/050839

§ 371 Date: Mar. 4, 2015

(30) Foreign Application Priority Data
Sep. 5, 2012 (FI) 20125917

(51) Int. Cl. F24F 7/08; B65G 53/14; A62B 99/00; B65F 5/00

(52) U.S. Cl. CPC F24F 7/08; B65F 5/005; B65G 53/14; A62B 99/00; F24F 2001/0088

(57) ABSTRACT

Method for extracting smoke and combustion gases from a space, in which method the combustion gases are conducted into a duct in which suction is acting. The smoke and combustion gases are conducted from the space into the conveying piping of a pneumatic material-conveying system. The invention also relates to an apparatus and to use.

### BACKGROUND OF THE INVENTION

The invention relates to a method as defined in claim 1.

The invention also relates to an apparatus as defined in claim 14.

The object of the invention is also use as defined in claim 25.

The invention relates generally to pneumatic material-conveying systems, such as to partial-vacuum transporting systems, more particularly to the collection and conveying of wastes, such as to the conveying of household wastes.

Systems wherein wastes are conveyed in piping by means of suction and/or by means of a pressure difference are known in the art. In these, wastes are conveyed long distances in conveying piping. The apparatuses are used for, among other things, the conveying of wastes in different institutions. It is typical to these systems that a partial-vacuum apparatus is used to achieve a pressure difference, in which apparatus negative pressure is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. Such as these are presented in publications WO 2009/080880, WO 2009/080881, WO 2009/080882, WO 2009/080883, WO 2009/080884, WO 2009/080885, WO 2009/080886, WO 2009/080887 and WO 2009/080888, among others.

Systems of the type described are often used in large buildings or spaces, in which there is also often an increased risk of various accidents or fires. Smoke forms in conjunction with fires, which smoke causes significant damage and even loss of human life, more particularly in connection with apartment fires, hotel fires, ship fires or tunnel fires. In fire situations, smoke generation and combustion gases form a very great hazard. Various solutions are known in the art for extracting smoke and combustion gases from buildings. Often complex arrangements must be arranged for these. In one solution according to prior art at least one spray head spraying when activated extinguishing medium at high pressure, said spray head being arranged inside a ventilation duct, is used to reduce the detrimental effects of smoke. One such solution is presented in U.S. Pat. No. 5,957,212. In it, smoke is conducted from a space into an air-conditioning duct by spraying an extinguishing medium with a nozzle in the duct in such a way that a suction forms from the space into the duct. One drawback, among others, of prior art is that the fire can also spread via the air-conditioning ducts.

The aim of the invention is to achieve a new type of method and apparatus for extracting smoke and combustion gases, by means of which the drawbacks of prior art are avoided. Another aim of the invention is to achieve a system for extracting smoke and combustion gases from a building and from different spaces by utilizing a system that is primarily in some other use also in the extraction of smoke and combustion gases.

### BRIEF DESCRIPTION OF THE INVENTION

The invention is based on a concept wherein a pneumatic material-conveying system, more particularly a wastes-conveying system, is utilized in the extraction of smoke and combustion gases. According to an embodiment of the invention smoke and combustion gases are extracted from a space by opening a connection from the space into a conveying pipe of a pneumatic conveying system for material, in which case the smoke and combustion gases are conveyed from the space into the conveying piping. According to an embodiment of the invention the smoke and combustion gases are cooled with a spray head before they are conducted into the material-conveying piping or into a duct leading into the material-conveying piping or they are cooled in the duct or in the material-conveying piping.

The method according to the invention is characterized by what is stated in claim 1.

The method according to the invention is also characterized by what is stated in claims 2-13.

The apparatus according to the invention is mainly characterized by what is stated in claim 14.

The apparatus according to the invention is also characterized by what is stated in claims 15-24.

The invention is also characterized in that a pneumatic material-conveying system, more particularly a wastes-conveying system, is used in the extraction of smoke and combustion gases.

The solution according to the invention has a number of important advantages.

According to the invention the conveying piping of a pneumatic material-conveying system can be utilized in the extraction of smoke and combustion gases. The solution enables the effective extraction of smoke and combustion gases from spaces in which there are no other systems for smoke extraction. The solution extends the range of use of pneumatic material-conveying systems to also include fire situations. In pneumatic material-conveying systems, more particularly in waste-conveying systems, the airflows in the conveying piping are large, in which case highly effective smoke extraction from a space into the conveying piping is achieved. With the solution according to the invention suction power many times more than that of a prior-art solution is achieved. According to the invention the smoke and combustion gases are cooled with a spray head. The spraying medium, such as water, is preferably sprayed in such a way that a cooling effect is achieved and saturation of the spraying medium. The spray head can, according to one embodiment, also be the spray head of a fire-extinguishing system. The solution according to the invention can be connected to function together with a fire-extinguishing system and/or together with a fire alarm system. In the solution according to the invention the spraying medium of a spray head can be utilized as a drive medium for the drive device of the valve means. The drive device of a valve means can also be cooled with the medium. According to one embodiment the extinguishing medium of a fire-extinguishing system can be utilized as a drive medium of the drive device of a valve means. By means of the invention smoke and combustion gases can be conducted completely out of the site, e.g. to a waste station, in which they are first cooled on the journey and then filtered in such a way that they do not cause environmental problems.

### BRIEF DESCRIPTION OF THE FIGS.

In the following, the invention will be described in more detail with reference to the attached drawings, wherein:

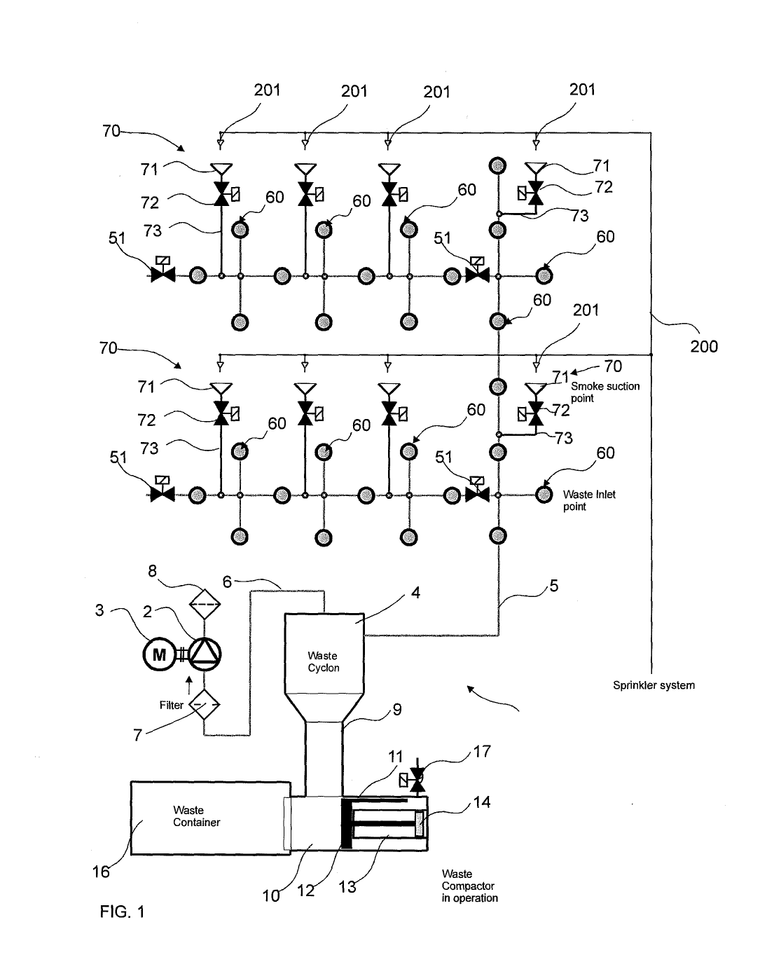

FIG. 1 presents a diagram of a system according to an embodiment of the invention, in a first operating phase,

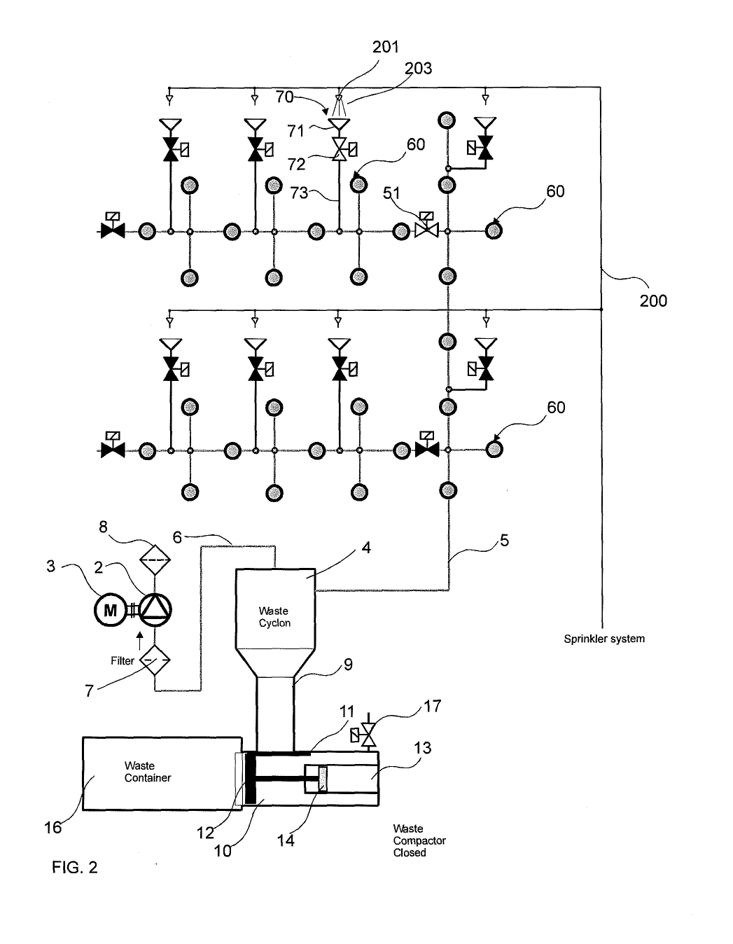

FIG. 2 presents a diagram of a system according to an embodiment of the invention as a diagram, in a second operating phase,

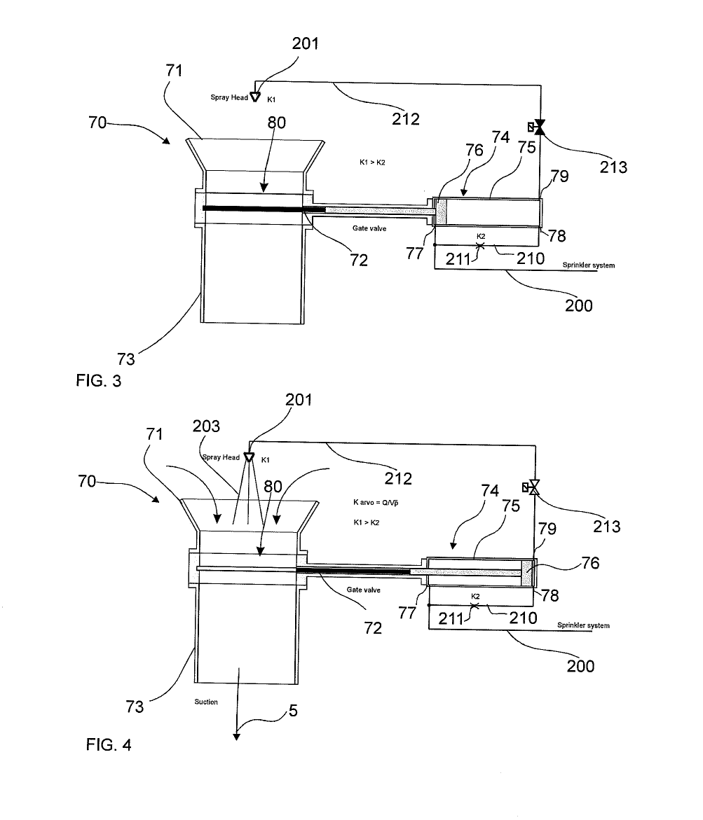

FIG. 3 presents a detail of an apparatus according to an embodiment of the invention, in a first operating phase,

FIG. 4 presents a detail of an apparatus according to an embodiment of the invention, in a second operating phase,

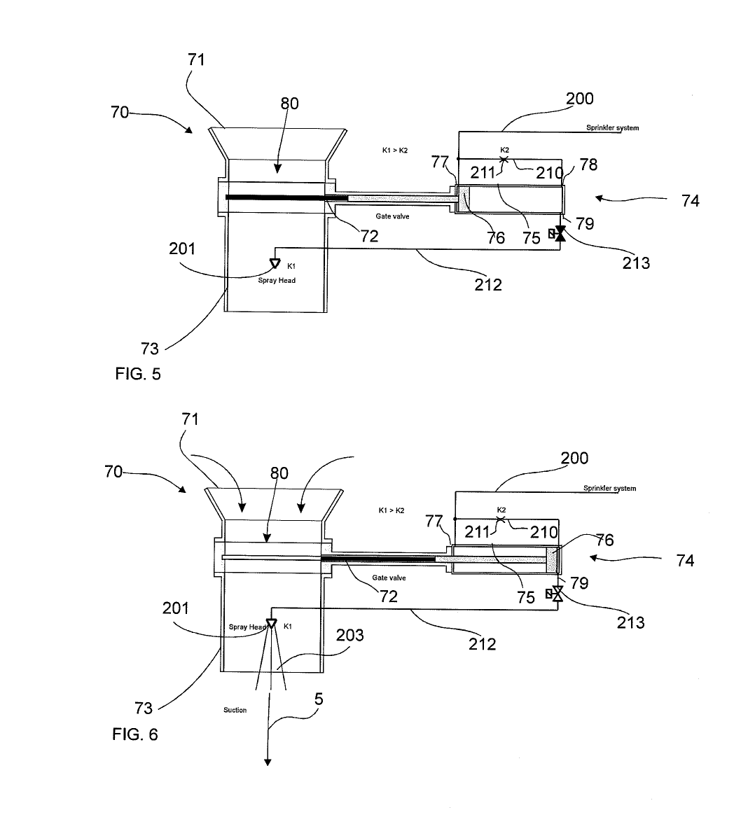

FIG. 5 presents a detail of an apparatus according to an embodiment of the invention, in a first operating phase,

FIG. 6 presents a detail of an apparatus according to an embodiment of the invention, in a second operating phase,

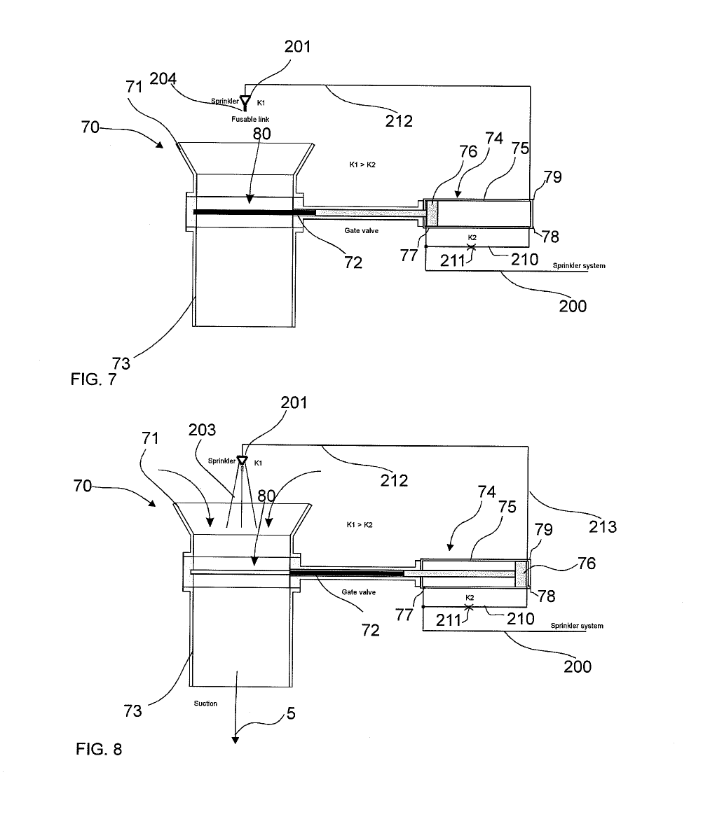

FIG. 7 presents a detail of an apparatus according to an embodiment of the invention, in a first operating phase,

FIG. 8 presents a detail of an apparatus according to an embodiment of the invention, in a second operating phase,

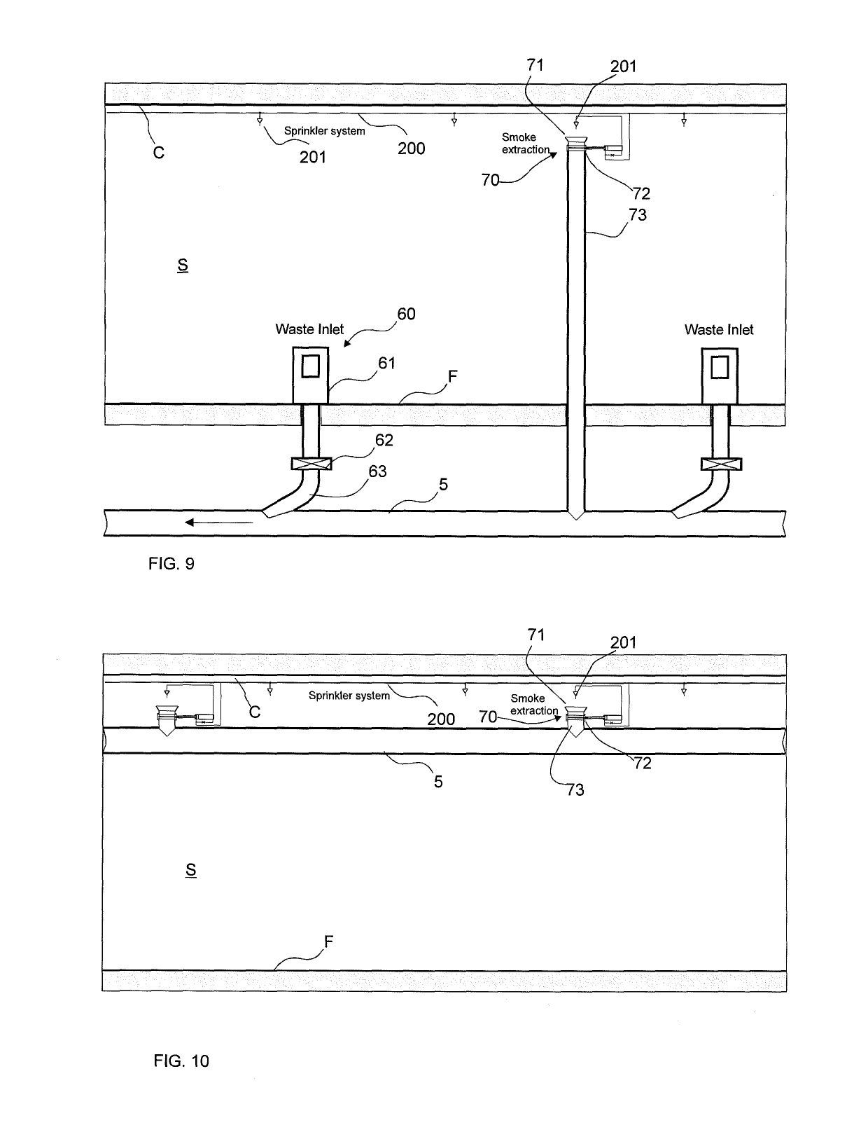

FIG. 9 presents a detail of an embodiment of the apparatus according to the invention, in a first application site,

FIG. 10 presents a detail of an embodiment of the apparatus according to the invention, in a second application site,

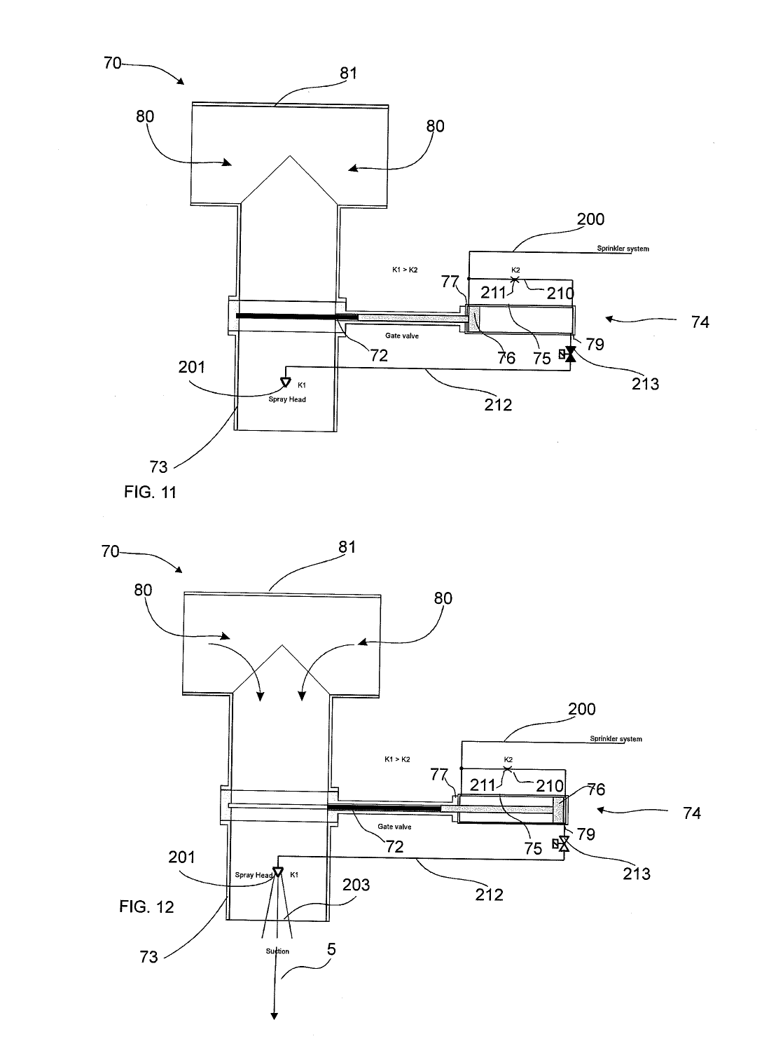

FIG. 11 presents a detail of an apparatus according to an embodiment of the invention, in a first operating phase, and

FIG. 12 presents a detail of an apparatus according to an embodiment of the invention, in a second operating phase.

### DETAILED DESCRIPTION OF THE INVENTION

FIG. 1 presents a simplified diagram of a pneumatic material-conveying system, in which the solution according to the invention is applied. In the description the invention is presented in connection with a pneumatic waste-conveying system, but in principle the invention can be applied as a part of some other type of pneumatic material-conveying system.

The partial-vacuum generator 2 of the pneumatic pipe conveying system for wastes, which generator is driven with a drive device 3, is connected with a pipeline 6 from the suction side of the partial-vacuum generator to a separating means 4, which can be e.g. a cyclone separator. The conveying piping 5 of the pneumatic waste-conveying system is connected to the separating means 4, e.g. to the top part of the separating means, in which case the waste material to be conveyed separates from the conveying air in the separating means 4. The heavier particles and waste travel in the separating means, e.g. by means of centrifugal force and/or gravitational force, into the bottom part 9 of said separating means, from where they are emptied from time to time, e.g. into a waste container 16.

The conveying air separated from the wastes, for its part, is conducted from the separating means 4, from the output aperture of its top part, to the blowing side of the partial-vacuum generator 2 and onwards into an exhaust pipe, which in the figure is provided with a filtering means 8.

In the embodiment according to the figure, a material press is applied between the between the bottom part 9 of the separating means and the waste container, which press compacts the material and conveys it from the space 10 of the press into the waste container 16, such as into a freight container. The press comprises a compression means 12 and a shut-off means 11, which are moved with a drive device 13, 14. The shut-off means 11 closes the connection from the separating means 4 into the space 10 of the press and into the waste container 16. In FIG. 1 the connection from the separating means 4 into the space 10 of the press is open and the compression means 12 is in standby mode for pressing waste towards the container 16. In FIG. 2 the connection from the separating means 4 into the space 10 of the press is closed with the shut-off means 11. The drive device 13, 14 is e.g. a cylinder-piston unit, in which the compression means 12 is connected to the piston rod 14. The piston moves in the cylinder 13 in a manner that is, per se, known in the art, e.g. driven by a pressure medium. The valve 17 in the chamber of the compression means is closed in the situation of FIG. 1, and open in the situation of FIG. 2.

In FIGS. 1 and 2 a number of inlet points 60 are arranged in the material-conveying piping 5. An inlet point 60 is a feed-in station of material, more particularly of waste material, intended to be conveyed, from which station the material, more particularly waste material, such as household waste, intended to be conveyed is fed into the conveying system. The system can comprise a number of inlet stations 60, from which the material intended to be transported, e.g. household waste or other material packed into bags, is fed into the conveying piping. In FIG. 9 the components of an inlet point are described with reference numbers in connection with two inlet points 60. An inlet point 60 typically comprises a feed-in container 61, which can be connected to an inlet pipe 63. The inlet pipe comprises at least one valve means 62, by opening and closing which material can be transferred from the inlet point 60 into the conveying pipe 5. An inlet pipe 63 can be connected to a conveying pipe 5 also via branch conveying pipe. The conveying piping 5 can be formed from a number of conveying pipe sections, which are separated from each other with valve means 51. The conveying piping can also comprise replacement air couplings, which are provided with a valve means, by means of which the access of the replacement air into the conveying pipe 5 can be adjusted.

The replacement air needed in emptying the feed-in container 61 of an inlet point 60 comes, in the embodiment of FIG. 1, via the feed-in container 61. According to a second embodiment a separate replacement air branch coupling can additionally be in connection with an inlet point.

The apparatus comprises means for conducting smoke and combustion gases from the desired space S into the conveying piping 5 of a pneumatic material-conveying system. The means for conducting smoke and combustion gases from the space S into a conveying pipe comprise a connection arranged in the space S, or in the proximity of it, to a conveying pipe 5 of a pneumatic material-conveying system, which connection is configured to open for conducting smoke and combustion gases into the conveying pipe 5 from the space S.

The connection from the space S to the conveying pipe can be arranged via a suction point 70 for smoke and combustion gases arranged in the space, which suction point is connected by a suction duct 73 to the conveying pipe 5.

According to one embodiment of the invention a suction point 70 for smoke and combustion gases is arranged from a conveying pipe 5 of a pneumatic material-conveying system into a desired space S. The suction point 70 can be a suction aperture 80 opening into the desired space S (FIG. 9 or 10), which suction aperture is formed in the conveying pipe 5. The suction point could be connected with a duct section 73 to the conveying pipe 5. According to one embodiment between the suction point 70 and the conveying pipe 5 is a valve means 72, which is arranged to open in the event of a fire for conducting smoke and combustion gases from the space S into the conveying piping 5. An expansion 71, e.g. a conical expansion, can be in connection with the aperture of a suction point 70.

According to the invention in a fire situation the suction brought about in the conveying piping 3 by a partial-vacuum generator 2 of a pneumatic material-conveying system is utilized, in which case in the fire situation the connection from a suction point 70 to the conveying piping 5 opens and smoke as well as combustion gases exit from the space S via the suction point 70 into the conveying piping 5. According to one embodiment smoke and combustion gases, the temperature of which is often e.g. in the region of 300-500 degrees C., are cooled by spraying water into the piping, most suitably to near the suction point 70. In the embodiment of the figures a spray head 201 of a sprinkler system 200 is utilized in the cooling of the smoke and combustion gases being conducted into a suction point 70. The spray head 201 can be the spray head of a separate sprinkler system. A sprinkler system typically comprises a spraying medium source (not presented), such as a container, e.g. a pressure container, or a connection to a water pipe, as well as a pump device, which is connected to the piping leading to the spray head of the sprinkler system to deliver spraying medium, if necessary, to the piping. It can also be conceived that the spray head is the nozzle of a fire extinguishing system. Typically, however, smoke extraction is continued at the fire site for longer than the fire-extinguishing system is configured to spray, in which case in the embodiment of the invention the spray head must therefore be configured to spray, if necessary, although the area valves, or corresponding, of the fire-extinguishing system are closed.

According to one embodiment of the invention in FIG. 1 there is a spray head 201 at the point of each suction point 70, which spray head is directed to spray towards the suction aperture 80 of the suction point 70. A number of suction points can be arranged in a conveying pipe, e.g. distributed along the length of the conveying piping. According to one embodiment suction points 70 are arranged in only a part of the conveying piping, e.g. in only the desired spaces S. An expansion 71 of a suction point 70 can, on the other hand, better guide smoke and combustion gases into the suction aperture 80 of the suction point and/or better limit and guide the spray 203 of a spray head 201 towards the suction aperture 80 of the suction point. FIGS. 11 and 12 present an embodiment wherein the suction point 70 comprises a number of suction apertures 80. A component that distributes the suction to a number of suction apertures can be arranged in a suction point. Such a component is e.g. a T-piece 81 arranged in the pipe. A T-piece 81 distributes the suction to two suction apertures 80, in which case the strength of the suction of a suction point towards the suction aperture can be reduced.

FIG. 2 presents a situation in which one of the suction points 70 has been activated, in which case the connection of it from the conveying pipe 5 to the suction aperture 80 has opened. Simultaneously, the spray head 201 at the point of the suction point has activated to spray water. The connection from the conveying pipe section to the separating means 4 has been opened by opening the conveying pipe valve 51. Correspondingly, the connection from the separating means 4 to the press 10 is closed with the shut-off means 11. A filtering means 7 is arranged in the pathway 6 of the medium from the separating means to the partial-vacuum generator. Correspondingly, the exhaust duct of the partial-vacuum generator 2 comprises a filtering means 8. According to the invention smoke and combustion gases are conducted in a controlled manner along a conveying pipe of a material-conveying system, under the effect of suction/a pressure difference/airflow brought about in the conveying pipe 5 by a partial-vacuum generator 2, onwards to the exhaust side of the partial-vacuum generator and, when filtered, onwards out via an exhaust duct. The exhaust is arranged, according to one embodiment, in connection with an area waste station, which can be a significant distance away from the location from which the smoke and combustion gases are extracted.

According to one embodiment the valve means 72 of a suction point 70 is configured to open under the control of an extinguishing system.

In FIGS. 3-8 different alternatives are presented for opening the valve means 72 of a suction point 70 and for activating a spray head to spray.

FIGS. 3 and 4 present an embodiment wherein a spray head 201 is activated by opening a solenoid valve 213, e.g. on the basis of the signal of a fire detector (not presented) or on the basis of a fire alarm or manual activation. The figures present a drive device 74 of a valve means 72 of a suction point 70, which drive device is a cylinder-piston unit in the figure. The drive device comprises a cylinder part 75, in the cylinder part of which is a piston part 76 arranged to be moved between two positions. The first position is presented in FIG. 3, in which the valve means 72, which is connected to the piston rod of the piston 76, is in front of the pathway of the suction aperture, in which case the connection from the suction point 70 to the conveying pipe 5 is closed. FIG. 4 presents a second position, in which the piston 76 is in the second position (to the right in FIG. 4) in the cylinder space of the cylinder 75. In this case the shut-off means 72 has also shifted into the second position and the pathway from the suction point to the conveying pipe 5 is open. The drive device 74 of the valve means is connected to the medium piping 200 of the sprinkler system in such a way that when the solenoid valve opens, the pathway from the suction point 70 into the conveying piping 5 also opens. This can be implemented e.g. by arranging a first medium pathway 77 into the cylinder 75 from the medium piping 200 into the cylinder space to the piston rod side (i.e. to the shut-off means side) and a second medium pathway 78 into the cylinder along the duct 210 into the cylinder space to the opposite side of the piston 76 with respect to the first medium pathway 77. From the cylinder space is a third medium pathway 79 into the pipeline 212 going to the spray head 201, in which pipeline is a solenoid valve 213.

The second medium pathway or duct 210 has a flow resistance or choke means 211, the k-value (K2) of which is smaller than the k-value (K1) of the nozzle 201. In this case when there is pressure in the piping and the valve 213 opens, the piston 76 shifts from the position of FIG. 3 into the position of FIG. 4 and the connection from the suction point 70 to the conveying piping 5 opens.

The nozzle flow rate follows the equation Q=k√p, in which equation Q is the flow rate, p is the pressure that pushes the medium through the nozzle and k is the resistance of the nozzle. The value of the factor k depends on, inter alfa, the surface area of the aperture of the nozzle. If the aperture is round, the value of the factor k depends on the diameter d of the aperture as follows k=0.78*d², when the aperture is a so-called short aperture.

Correspondingly, the spray head 201 starts to spray medium 203 for cooling the smoke and combustion gases. In FIG. 4 the spray head is directed towards the suction aperture 80 of the suction point 70. In this case the combustion gases in the proximity of the suction point travel as a consequence of the suction of the conveying piping 5, and possibly also as a consequence of the suction effect brought about by the spray head, from the suction aperture along the suction duct 73 into the conveying piping 5.

In the embodiment according to FIGS. 3 and 4 the spray head 201 can be a so-called open spray head, in which case it starts to spray when the valve 213 is opened.

In addition, the medium flowing in the medium piping also cools the drive device 74 of the valve means 72.

FIGS. 5 and 6 present a corresponding solution to that in FIGS. 3 and 4, the only difference being that the spray head 201 in them is arranged in a suction duct 73. In this case the smoke and combustion gases are conducted into the suction duct by spraying medium with the spray head in the suction duct 73 in such a way that suction from the space forms in the suction duct.

FIGS. 7 and 8 present an embodiment wherein the spray head 201 is provided with a triggering means 204, such as an ampoule that breaks at a certain temperature, which ampoule releases the spray head 201 to spray medium 203. In this case the drive device 74 of the valve means 72 of the suction point 70 shifts the valve means 72 into the open position (FIG. 8). The suction of the conveying pipe is able to act in the space S and to extract smoke and combustion gases from there. The medium sprayed by the spray head cools the gases in the suction duct. On the other hand the suction achieved by it boosts the conveying of smoke and gases from the space S into the suction duct 73 and onwards into the conveying pipe 5.

The water spraying into the piping typically evaporates and saturates in the piping, so that it is not detrimental to the material-conveying apparatus. According to one embodiment a medium mist, more particularly a water mist, is sprayed with a spray head.

It is, however, advantageous for the system that the connection from the separating means 4 to the material container is closed with a shut-off means 11, so that the access of possibly hot and burning material into the body of waste material is prevented.

FIG. 9 presents an embodiment wherein the suction point 70 has been taken with a suction duct 73 into a different space S with respect to the conveying pipe 5, from which space it is desired to extract any smoke and combustion gases in the event of a fire. It can be conceived that the conveying pipe 5 travels in FIG. 9 e.g. underground or in a cellar space and the suction point 70 is arranged in the same space S as the inlet points 60 for wastes, above the floor level F. In the figure it is also taken into account that smoke and combustion gases typically rise into the top part of the space S, e.g. to close to the ceiling C, in which case the suction point 70 is arranged in the top part of the space S, e.g. near the ceiling C. In the figure, the spray heads 201 of the sprinkler system are also arranged in the top part of the space S. The suction point 70 can also be in another space than that in which the inlet points 60 for wastes are disposed. A suction point 70 can also be in a different space S than that in which the conveying piping 5 is arranged to travel. In this case a connection to the conveying piping 5 can be arranged with a suction duct 73 to the space S.

FIG. 10 presents an embodiment in which a conveying pipe 5 is arranged to travel in the top part of a space S, typically near the ceiling C, in which top space also the pipe 200 of the sprinkler system is configured to travel and in which the spray heads 201 are disposed. In the embodiment of FIG. 10 the suction duct 73 of the suction point is rather short. An example of this type of space is a corridor space, a cellar space or a tunnel.

FIGS. 11 and 12 further present an embodiment, which corresponds in its basic structure to the embodiment presented in FIGS. 5 and 6. In the embodiment of FIGS. 11 and 12, the suction point 70 comprises a number of suction apertures 80. A component that distributes the suction to a number of suction apertures 80 can be arranged in a suction point 70, in which case the strength of the suction of a suction point towards the suction aperture can be reduced. This type of solution is e.g. a T-piece 81 arranged in the pipe 73. In the embodiment of the figure the T-piece 81 divides the suction into two suction apertures 80. There can also be a number of suction apertures 80 in connection with a suction point 71.

The invention thus relates to a method for extracting smoke and combustion gases from a space, in which method the combustion gases are conducted into a duct in which suction is acting. In the method the smoke and combustion gases are conducted from the space S into the conveying piping 5 of a pneumatic material-conveying system.

According to one embodiment in the method smoke and combustion gases are conducted via a suction duct 73 of a suction point 70 arranged in the space S into the conveying piping 5 for material.

According to one embodiment in the method suction is achieved in the conveying pipe 5 with a partial vacuum generator 2.

According to one embodiment in the method liquid is sprayed with a spray head 201, which is arranged in a suction point or in the proximity of it.

According to one embodiment a spray head 201 is arranged outside a suction duct 73 leading to the conveying pipe 5 of a suction point 70 or outside the conveying pipe 5.

According to one embodiment a spray head 201 is arranged in a duct 73 leading to a conveying pipe 5 of a suction point 70.

According to one embodiment in the method a connection is opened with a valve means 72 from the space S to the suction duct 73 and onwards into the conveying pipe 5.

According to one embodiment the smoke and combustion gases are cooled by spraying medium 203 with a spray head 201, preferably in the space S or in a duct 73 leading to the conveying pipe 5 or in the conveying pipe 5.

According to one embodiment the valve means 72 of the suction duct is driven with a drive device 74, which is configured to function with the spraying medium of the sprinkler system, more particularly with water.

According to one embodiment the valve means 72 is configured to be opened with pressure medium or with electricity or mechanically.

According to one embodiment the smoke and combustion gases are conducted along a conveying pipe 5 into an outlet pipe on the blowing side of a partial-vacuum generator 2 of a pneumatic material-conveying system.

According to one embodiment the space S is in a building, in a vessel or in a tunnel.

According to one embodiment the pneumatic material-conveying system is a wastes-conveying system.

The invention also relates to an apparatus in a pneumatic material-conveying system, which comprises at least one inlet point 60, conveying pipe means 5 for conducting material from the inlet point 60 to a separating means 4, in which the material being transported is separated from the transporting air, and also a partial-vacuum generator 2 for achieving suction and/or a pressure difference in the conveying piping at least during the transporting of the material. The apparatus comprises means for conducting smoke and combustion gases from the desired space S into the conveying piping 5 of the pneumatic material-conveying system.

According to one embodiment the means for conducting smoke and combustion gases from the space S into a conveying pipe comprise a connection arranged in the space S, or in the proximity of it, to a conveying pipe of a pneumatic material-conveying system, which connection is configured to open for conducting smoke and combustion gases into the conveying pipe 5 from the space S.

According to one embodiment the connection is a suction point 70 for smoke and combustion gases, which suction point is connected by a suction duct 73 to a conveying pipe 5.

According to one embodiment the means further comprise a valve means 72 and a drive device 74 for the valve means.

According to one embodiment the apparatus comprises a spray head 201, which is arranged in a suction point, or in the proximity of it, and means 200 for conducting liquid to the spray head.

According to one embodiment a spray head is arranged in a space S outside the suction point.

According to one embodiment a spray head is arranged in a suction duct 73 or directed to spray into a suction duct 73.

According to one embodiment the apparatus is configured to activate a triggering means 204 of a spray head 201 as a consequence of the activation of a fire detector or smoke detector or as a consequence of manual activation.

According to one embodiment the drive device 74 of a valve means 72 is configured to function with the spraying medium, more particularly with the water, of a sprinkler system.

According to one embodiment the valve means 72 is configured to be opened with pressure medium or with electricity or mechanically. In this case the valve is opened e.g. with compressed air or with electricity. According to one embodiment an arresting means reacting to temperature is arranged in connection with a valve means 72 or its drive device 74, which arresting means is configured to release the valve means or its drive device for opening a connection when the temperature has risen to a certain temperature. The valve means or its drive device can in this case be arranged to function by means of a prestressing means, in which case it is e.g. spring-loaded. In this case the valve means opens when the arresting means (fusable link) reacting to temperature arranged in connection with the valve means or its drive device releases the valve, e.g. from the effect of heat that has risen to the certain temperature.

The invention also relates to use of a pneumatic material-conveying system, more particularly of a wastes-conveying system, in the extraction of smoke and combustion gases.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1-25. (canceled)

26. Method for extracting smoke and combustion gases from a space, in which method the combustion gases are conducted into a duct in which suction is acting, wherein the smoke and combustion gases are conducted from the space into the conveying piping of a pneumatic material-conveying system, comprising the following steps:
providing a suction duct wherein the smoke and combustion gases are conducted from the space via the suction duct of a suction point arranged in it into the conveying piping for material; and
arranging a spray head outside the suction duct leading to a conveying pipe of a suction point or outside the conveying pipe.

27. Method according to claim 26, wherein in the method suction is achieved in the conveying pipe with a partial vacuum generator.

28. Method according to claim 26, wherein in the method liquid is sprayed with a spray head, which is arranged in a suction point or in the proximity of it.

29. Method according to claim 26, wherein a spray head is arranged in a duct leading to a conveying pipe of a suction point.

30. Method according to claim 26, wherein in the method a connection is opened with a valve means from the space to the suction duct and onwards into the conveying pipe.

31. Method according to claim 26, wherein the smoke and combustion gases are cooled by spraying medium with a spray head, preferably in the space or in a duct leading to a conveying pipe or in the conveying pipe.

32. Method according to claim 26, wherein the valve means of the suction duct is driven with a drive device, which is configured to function with the spraying medium of the spray head, more particularly with water.

33. Method according to claim 26, wherein the valve means is configured to be opened with pressure medium or with electricity or mechanically.

34. Method according to claim 26, wherein the smoke and combustion gases are conducted along a conveying pipe into an outlet pipe on the blowing side of a partial-vacuum generator of a pneumatic material-conveying system.

35. Method according to claim 26, wherein the space is in a building, in a vessel or in a tunnel.

36. Method according to claim 26, wherein the pneumatic material-conveying system is a wastes-conveying system.

37. Apparatus for implementing a method according to claim 26 in a pneumatic material-conveying system, which comprises at least one inlet point, conveying pipe means for conducting material from the inlet point to a separating means, in which the material to be transported is separated from the transporting air, and also a partial-vacuum generator for achieving suction and/or a pressure difference in the conveying piping at least during the transporting of the material, wherein the apparatus comprises means for conducting smoke and combustion gases from the desired space into the conveying piping of the pneumatic material-conveying system, that the apparatus comprises a spray head, which is arranged in a suction point, or in the proximity of it, and means for conducting liquid to the spray head, and that a spray head is arranged in the space outside the suction point.

38. Apparatus according to claim 37, wherein the means for conducting smoke and combustion gases from the space into a conveying pipe comprise a connection arranged in the space, or in the proximity of it, to a conveying pipe of a pneumatic material-conveying system, which connection is configured to open for conducting smoke and combustion gases into the conveying pipe from the space.

39. Apparatus according to claim 37, wherein the connection is a suction point for smoke and combustion gases, which suction point is connected by a suction duct to the conveying pipe.

40. Apparatus according to claim 37, wherein the means further comprise a valve means and a drive device for the valve means.

41. Apparatus according to claim 37, wherein a spray head is arranged in a suction duct or directed to spray into the suction duct.

42. Apparatus according to claim 37, wherein the apparatus is configured to activate a triggering means of a spray head as a consequence of the activation of a fire detector or smoke detector or as a consequence of manual activation.

43. Apparatus according to claim 37, wherein the drive device of a valve means of a suction point is configured to function with the spraying medium, more particularly with the water, of the spray head.

44. Apparatus according to claim 37, wherein the valve means is configured to be opened with pressure medium or with electricity or mechanically.

45. Apparatus according to claim 37, wherein an arresting means reacting to temperature is arranged in connection with a valve means or its drive device, which arresting means is configured to release the valve means or its drive device for opening a connection when the temperature has risen to a certain temperature.

46. Use of a pneumatic wastes-conveying system in the extraction of smoke and combustion gases.
